(19) United States
(12) Patent Application Publication
(10) Pub. No.: US 2003/0146113 A1
(43) Pub. Date: Aug. 7, 2003

(54) Electrochemical sensor for determining blood clotting, corresponding system for measuring blood clotting and method for determining blood clotting

(76) Inventors: Volker Unkrig, Ladenburg (DE); Michael Marquant, Mannheim (DE); Fritz Hindelang, Carlsberg (DE); Holger Kotzan, Ladenburg (DE); Carina Horn, Alsbach-Haehnlein (DE); Christine Nortmeyer, Mannheim (DE)

Correspondence Address: Michelle Neff, Roche Diagnostics Corporation, 9115 Hague Road, Indianapolis, IN, 46250-0457, US

(21) Appl. No.: 10/204,524

(22) PCT Filed: Feb. 19, 2001
(86) PCT No.: PCT/EP01/01848

(30) Foreign Application Priority Data
Feb. 21, 2000 (DE) 100 07 910.5
Apr. 4, 2000 (DE) 100 16 775.6

(51) Int. Cl. G01N 27/26

(52) U.S. Cl. 205/792; 204/403.01; 204/403.14

(57) ABSTRACT

The invention concerns an electrochemical sensor based on dry chemistry for determining blood coagulation or individual coagulation factors which has at least two electrodes on an inert support as well as a dry reagent, characterized in that the reagent contains a protease substrate which is composed of a peptide residue that can be cleaved off by a thrombin and is bound to a phenylenediamine residue via an amide bond at its carboxyl end and

a system for measuring blood coagulation containing such a sensor and an amperometer,

a method for determining blood coagulation using the sensor according to the invention and a reagent for determining blood coagulation containing a thrombin substrate which is composed of a peptide residue that can be cleaved off by thrombin and is bound via its carboxyl end to a phenylenediamine residue by means of an amide linkage, characterized in that it also contains a dye-oxidoreductase such as glucose-dye-oxidoreductase.

The invention concerns a sensor based on dry chemistry for the determination of blood coagulation which has at least 2 electrodes on an inert support and a dry reagent. The invention additionally concerns a blood coagulation measuring system containing an electrochemical sensor and an instrument for measuring electrical current. Finally the invention also concerns a method for determining blood coagulation by means of an electrochemical sensor.

EP-B 0 441 222 describes a method and sensor electrode system for the electrochemical determination of an analyte or an oxidoreductase. The patent document discloses the role of a reducible substance as an electron carrier in a redox reaction of an analyte to be determined on an electrode. A typical analyte is glucose, lactate or a redox enzyme such as glucose dehydrogenase or lactate dehydrogenase.

An electrochemical method for determining proteases and antiproteases is known from EP-B 0 018 002. This uses a protease or antiprotease substrate composed of an oligopeptide to which an aromatic or heterocyclic amine or polyamine is bound. The enzyme to be determined cleaves the bond between the carboxyterminal amino acid and the amine or polyamine and the amount of released amine or polyamine is determined electrochemically. The determination of freely mobile components of the blood coagulation cascade in solution is described.

An electrochemical sensor for coagulation detection is known from C. Bisson et al., “A microanalytical device for the assessment of coagulation parameters in whole blood”, Technical Digest Solid-State Sensor and Actuator Workshop, Hilton Head Island, S.C., USA, Jun. 8-11, 1998. This publication describes in general the possibility of using electrochemical coagulation sensors with amperometric detection. Details of the substrates used are for example not disclosed. Furthermore the described electrodes and test devices are complicated to manufacture and are thus unattractive for a mass market.

In general it can be stated that the prior art does not provide a simple and reliable starting point for electrochemical coagulation sensors and corresponding methods for coagulation detection.

In order to resolve this problem the present invention provides an electrochemical sensor, a measuring system for blood coagulation and a method for determining blood coagulation as described in the independent patent claims. Preferred embodiments are given in the dependent claims.

The sensor according to the invention is an analytical element based on dry chemistry. The sensor contains at least two electrodes of which at least one electrode is a so-called working electrode. In a preferred embodiment it contains no classical reference electrode such as an Ag/AgCl reference electrode, but only at least one working electrode and one counterelectrode. The electrodes can be composed of all conventional electrode materials such as metals, noble metals, alloys or graphite and are preferably composed of noble metals such as gold or palladium, or graphite. The various electrodes of the sensor can be composed of the same or different materials. In a particularly preferred embodiment the sensor contains a working electrode and a counterelectrode that are both made of palladium.

The dry reagent of the sensor according to the invention contains for example the compound (I)

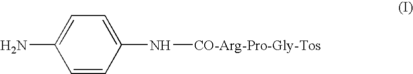

as a thrombin substrate. Arg denotes arginine, Pro denotes proline and Gly denotes glycine; Tos corresponds to the amino protecting group tosyl. In general any residues that can be cleaved by thrombin can be used as peptide residues of the thrombin substrate according to the invention such that phenylenediamine that can be determined electrochemically is released from the substrate.

The enzyme thrombin is the last protease of the coagulation cascade and is only formed during blood coagulation from the protein prothrombin. Hence it is possible to monitor the clotting of blood and thus determine clotting time by measuring the enzyme activity of thrombin.

When the thrombin substrate is cleaved, a p-aminoaniline (phenylenediamine) is formed which is oxidized on the working electrode of the sensor as described in EP-B 0 441 222. The released electrons are detected. Basically all the compounds which are described as electron carriers (or mediators) of type 2 in EP-B 0 441 222 can in principle be used as the electrochemically detectable part of the thrombin substrate according to the invention.

In the present invention it has turned out to be particularly advantageous to add the reagent glucose-dye-oxidoreductase (GlucDOR) to the reagent as an amplification system which oxidizes the glucose present in the blood to be examined and in this process uses the type 2 electron carrier released by the thrombin activity as an electron acceptor.

The reaction scheme is as follows:

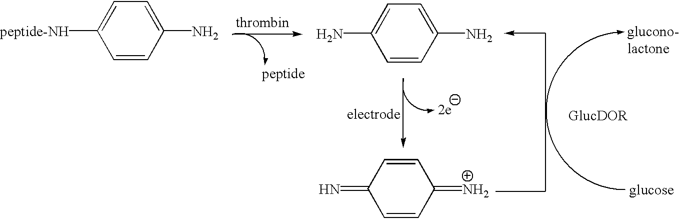

The primary oxidation product of the type 2 electron carrier is a quinone diimine which can be recycled in the form of p-aminoaniline by means of a dye oxidoreductase such as glucose-dye oxidoreductase (GlucDOR) and can thus again transfer electrons to the working electrode. Hence it is possible to considerably amplify the original signal. In addition to GlucDOR, there are other enzymes (such as alcohol dehydrogenase or oxidases such as glucose oxidase or lactate oxidase) which can convert the quinone diimine into phenylenediamine. Additional special substrates (corresponding to the glucose for GlucDOR) are required for this (such as alcohols for the enzyme alcohol dehydrogenase or lactate for lactate oxidase) which can then be optionally incorporated in suitable amounts into the reagent formulation.

The electrochemical determination of blood coagulation occurs quasi-potentiostatically, preferably using a 2 electrode system in which one electrode operates simultaneously as a reference and counterelectrode and the other electrode operates as a working electrode. A constant voltage is applied to this 2 electrode system and the current is measured over time. This method is also referred to as an amperometric measurement procedure. In order to determine the blood clotting time, the current time course is measured and it is determined after which time period from the start of the coagulation measurement the measured current exceeds a predetermined threshold value. This time period is a measure for the clotting time.

In addition to the amperometric measuring methods, it is also possible to use voltammetric measuring methods. In this case the voltage between the electrodes is not set to be constant, but rather the voltage is changed linearly from an initial value to a final value and subsequently returned to the initial value. This process can be repeated several times over the entire measurement period.

In the voltammetric method the current is plotted against the voltage and then when this is repeated one obtains a nested set of current-voltage curves (cyclovoltammograms). If the voltage range is suitable, oxidation peaks and reduction peaks of the electron carrier are formed in these curves. The height of these peaks is directly proportional to the concentration of the electron carrier provided that other redox-active substances are not co-oxidized or co-reduced in the covered potential range and thus additionally contribute to the current. Such an interference may be ignored when measuring a concentration change.

If the current values for the peak maxima or the areas enclosed by the curves (corresponding to the charge turnover) of the individual current voltage loops are plotted against time, one also obtains a picture of the concentration change of the electron carrier over the measurement period in a time raster given by the cycle period. This information can then be used—as in the amperometric methods—to determine the blood clotting time.

Oligopeptide derivatives of the following general formula (II) are used for a coagulation test which is based on the determination of the enzyme activity of a protease e.g. thrombin:

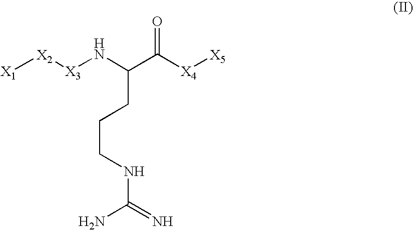

In this case X₁, X₂ and X₃ represent natural or artificial amino acids including possible protective groups. The sequence X₁-X₂-X₃ is selected according to the desired application, for example for detection by means of thrombin, and has been described for various purposes in numerous publications (cf. e.g. U. Becker et al., Clin. Chem., 30 (4), 524-528 (1984); M.-C. Bouton et al., Eur. J. Biochem., 229 (2), 526-532 (1995); H. D. Bruhn et al., “Hämostaseologie”, 15 (1), 54-56 (1995); E. De Candia et al., Thromb. Haemostasis, 77 (4), 735-740 (1997); P. L. Coleman et al., Clin. Chem., 29 (4), 603-608 (1983); J. DiMaio et al., J. Med. Chem., 35, 3331-3341 (1992); A. Frigola et al., J. Clin. Pathol., 32 (1), 21-25 (1979); P. J. Gaffney et al., Thromb. Res., 10 (4), 549-556 (1977); J. Hofsteenge et al., Biochem. J., 237, 243-251 (1986); R. Lottenberg et al., Thromb. Res., 28, 313-332 (1982); M. K. Ramjee, Anal. Biochem., 277, 11-18 (2000); J. J. Slon-Usakiewicz et al., Biochem. 36, 13494-13502 (1997); S. A. Sonder et al., Clin. Chem. 32 (6), 934-937 (1986); C. Soria et al., Thromb. Res., 19 (3), 435-440 (1980); T. Steinmetzer et al., J. Med. Chem., 42, 3109-3115 (1999); A. Tripodi et al., Clin. Chem., 30 (8), 1392-1395 (1984); J. I. Witting et al., Thromb. Res., 46 (4), 567-574 (1987); EP-B 0 018 002; U.S. Pat. No. 5,108,890; U.S. Pat. No. 5,190,862; EP-A 0 280 610; EP-B 0 144 744). Furthermore some of these amino acid sequences are also offered commercially by various companies to detect different coagulation factors for example from Pentapharm Ltd, Basle, Switzerland or from Chromogenix Germany, Haemochrom Diagnostica GmbH, Essen, Germany.

A moiety X₄-X₅ is attached as a leaving group to the amino acid sequence X₁-X₂-X₃ and is cleaved by the proteolytic activity of the coagulation factor i.e. thrombin for example. Depending on the desired detection principle, the moiety X₄-X₅ that is used to detect the proteolytic activity is coloured (photometric determination), fluorescent (cf. inter alia M. K. Ramjee, Anal. Biochem., 277, 11-18 (2000)) or electroactive (cf. EP-B 0 018 002).

The moiety X₄-X₅ is electroactive within the scope of the present invention i.e. can be converted at an electrode with release or uptake of electrons. X₄-X₅ preferably has a maximum oxidation potential of 350 mV relative to an Ag/AgCl electrode and can be detected by an electrochemical measurement.

In this connection X₄ can be an atom or group which forms the link with the oligopeptide sequence N or NH.

The moiety X₅ can have the following structure (III)

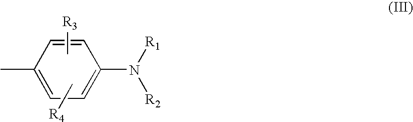

in which R₁ and R₂ are independently of one another alkyl, hydroxyalkyl, alkoxy-alkyl, phosphoramide alkyl, polyhydroxyalkyl, sulfone alkyl or hydrogen and R₃ and R₄ are OH, O-alkyl, alkyl, H, halogen, NR₁R₂, CO₂R, CONR₁R₂, SR₁, NR₁—CO—R₁, O—CO—R₁, H.

Peptide substrates of this type in which X₄=N or NH are for example described in the following patents or patent applications: JP-A 56042597; JP-A 58090535; WO-A 86/01209; U.S. Pat. No. 5,059,525; JP-A 61112096; JP-A 03157353.

X₅ can alternatively have the following structure (IV):

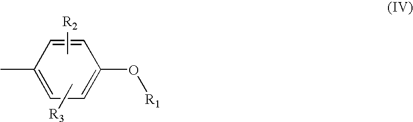

in which R₁ to R₃ have the meaning given above for formula III.

Peptide substrates of this type in which X₄=NR are known (cf. for example JP-A 03271299; EP-B 0 350 915; P. Kurzhals et al., Acta Pharm. Nord., 1 (5), 269-78 (1989); U.S. Pat. No. 4,797,472; EP-B 0 224 254; WO-A 87/05608; EP-B 0 170 797; EP-B 0 167 980; EP-B 0 152 872; EP-B 0 076 042; JP-A 52148032).

X₅ can alternatively have the following structure (V):

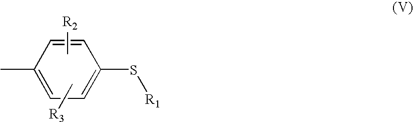

in which R₁ to R₃ have the meaning given above for formulae III and IV.

Peptide substrates of this type in which X₄=NR, O are known (cf. for example T. Morimoto et al., Pept. Chem., Vol. date 1989, 27^{th}., 387-390 (1999); N. Nishino et al., Pept. Chem., Vol. date 1988, 26^{th}, 21-24 (1989); B. J. Johnson et al., J. Org. Chem., 35 (1), 255-257 (1970)).

In a preferred embodiment the peptide substrate is a thrombin substrate of the general formula VI

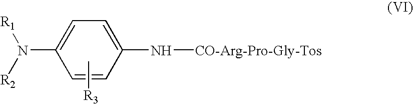

in which

R¹ denotes an alkyl residue or hydrogen,

R² denotes a hydroxy alkyl residue or hydrogen and

R³ denotes hydrogen, halogen, alkoxy or alkylthio.

Suitable protease substrates are generally compounds which are composed of a peptide residue that can be cleaved off by a protease of the blood coagulation system and are bound via an amide bond at the carboxyl end to substituted anilines and in particular to a phenylenediamine residue.

In addition to so-called global tests in which the clotting time is determined as such and which determine the activity of the protease thrombin for this purpose, appropriate alternative substrates known to a person skilled in the art can be used as a basis for other coagulation tests e.g. an anti-factor Xa test or to determine individual coagulation factors. For this it is necessary to adapt the peptide part of the substrate to the protease to be determined. For the electrochemical determination of coagulation or individual coagulation factors according to the invention it is important that a cleavage product of the peptide substrate that can be determined electrochemically is formed and detected.

The global tests include in particular the following tests: PT (prothrombin time test), aPTT (activated partial prothrombin time test) and ACT (activated clotting time test).

The invention is elucidated in more detail by the following examples. All examples are described using whole blood as the sample material. The sensors and methods according to the invention are, however, also suitable for citrate plasma if calcium is added to the formulation of the test support or to the sample. Furthermore it is possible according to the invention, in addition to the method mentioned in the examples, of applying the reagent to the electrodes (activators and substrate are both applied to the electrodes and subsequently dried), to not directly apply and dry the reagent to the electrode but in the vicinity of the electrodes for example next to the electrodes on a flat substrate. In this case the reagent is transported to the electrodes with the blood sample during the measurement. Alternatively it is possible to incorporate the reagent in porous materials such as fleeces, papers, membranes and such like, and for example to incorporate the reagent in a detachable form. In this case the blood or plasma sample has to flow through these materials before contact with the electrodes and in this process take up the reagent. It is also possible to apply individual components of the reagent to different compartments of the test support, for example the thrombin substrate on or directly adjacent to the electrode, but the activator spatially separated therefrom (e.g. further removed from the electrode) or to impregnate both substances in different layers (e.g. membranes or fleeces).

### EXAMPLE 1

Manufacture of a Coagulation Sensor for a PT Test

I. Description of the Electrochemical Function

a) Open two electrode system for “top dosing” sample application. Flat construction with 2 Pd electrodes. An Ag/AgCl paste (type: Acheson Electrodag 6037 SS) is dispensed over the whole area of a Pd electrode such that the entire surface of this Pd electrode is covered by Ag/AgCl.

The electrochemical operation occurs quasi-potentiostatically preferably as a 2 electrode system in which the Ag/AgCl electrode operates simultaneously as a reference and counterelectrode and the Pd electrode operates as a working electrode.

A constant voltage is applied to this two electrode system and the current is measured over time.

b) Replacement of the silver-silver chloride reference electrode by a soluble substance that can be reduced at the counterelectrode (type 2 mediator):

A soluble reducible substance is used which accepts electrons at the counter-electrode and thus ensures current transport through the counterelectrode. At the same time the reduction potential that can be reached at the working electrode is limited by the reduction potential of this substance and by the constant voltage applied to the sensor between the working and the counter-electrode. The p-aminoaniline to be detected at the working electrode by oxidation must be within the achievable oxidation potential. The potential at the working electrode against a hypothetical silver-silver chloride reference electrode must be such that the current through the working electrode (in this case anode) and the current through the counterelectrode (in this case cathode) are identical in terms of magnitude. The reducible substance should not at the same time be oxidizable at the working electrode within the maximum achievable oxidation potential since otherwise it would be superimposed on the signal of the p-aminoaniline cleaved in the previous enzymatic reaction.

II. Manufacture of a Dry Chemistry Format for a PT Test

a) Formulation of the bulk reagent:

| | | | |
|---|---|---|---|
| Concentration | | | |
| (in brackets allowed | | | |
| range according to | | Function of the | |
| the invention) | Substance | substance | Supplier |

Formulation 1: Ag/AgCl electrode configuration as described in 1.I.a):

| | | | |
|---|---|---|---|
| 0.6% (0.1-5%) | Avicel RC 591 | film former | FMC |
| | (carboxylated | | corporation |
| | microcrystalline | | |
| | cellulose) | | |
| 2% (0-5%) | Natrosol 250 M | thickener | Aqualon |
| 0.05% (0-5%) | Polyox 750 | film former | Union Carbide |
| 0.9% (0.05-5%) | Triton X100 | detergent | Sigma |
| 200 mM | HEPES | buffer | Roche |
| (10-500 mM) | | | |
| 0.1% (0.01-1%) | BSA | stabilizing | Roche |
| | (bovine serum | protein | |
| | albumin) | | |
| 0.1 μg/ml | rhTF | activator of the | Stago |
| (0.01-2 μg/ml) | (human recombi- | extrinsic path | |
| | nant tissue factor) | of plasmatic | |
| | | coagulation | |

Formulation 2: to be used with the type 2 mediator according to 1.I.b)

| | | | |
|---|---|---|---|
| 0.6% (0.1-5%) | Avicel RC 591 | film former | FMC |
| | (carboxylated | | corporation |
| | microcrystalline | | |
| | cellulose) | | |
| 2% (0-5%) | Natrosol 250 M | thickener | Aqualon |
| 0.05% (0-5%) | Polyox 750 | film former | Union Carbide |
| 0.9% (0.05-5%) | Triton X100 | detergent | Sigma |
| 200 mM | HEPES | buffer | Roche |
| (10-500 mM) | | | |
| 0.1% (0.01-1%) | BSA | stabilizing | Roche |
| | (bovine serum | protein | |
| | albumin) | | |
| 0.1 μg/ml | rhTF | activator of the | Stago |
| (0.01-2 μg/ml) | (human recombi- | extrinsic path | |
| | nant tissue factor) | of plasmatic | |
| | | coagulation | |
| 50 mM | p-nitroso-bis | type 2 mediator | Roche |
| (1-250 mM) | hydroxyethyl- | | |
| | aniline | | |

b) Metering and drying

5 μl of these suspensions were metered on the sensors described under 1.I.a) and b) and dried on a belt dryer or in a drying cabinet at 30 to 50° C. Formulation 1 is suitable for the sensor according to 1.I.a); formulation 2 is suitable for the sensor according to 1.I.b).

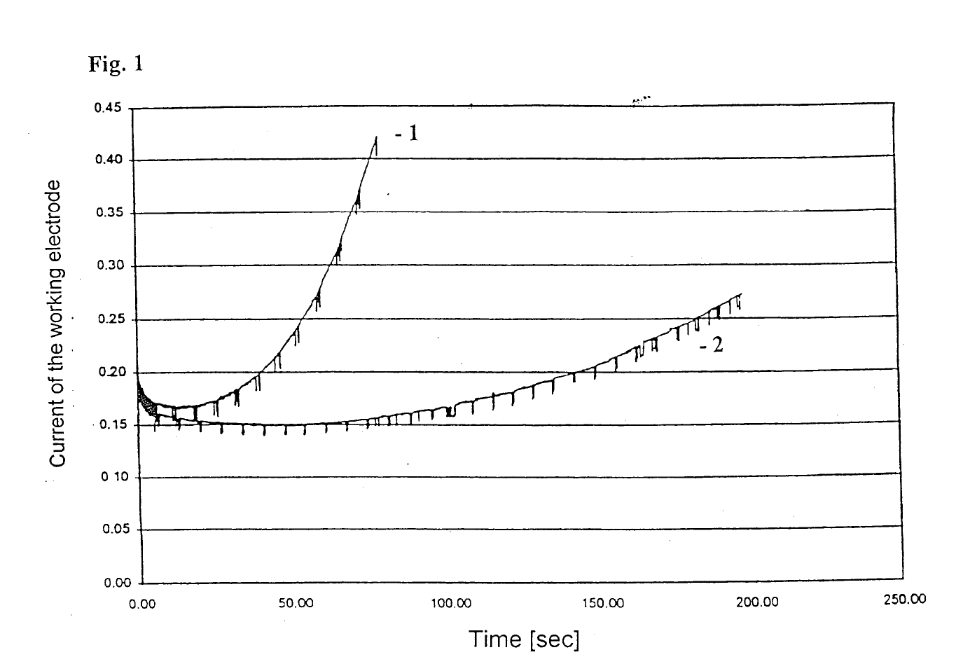

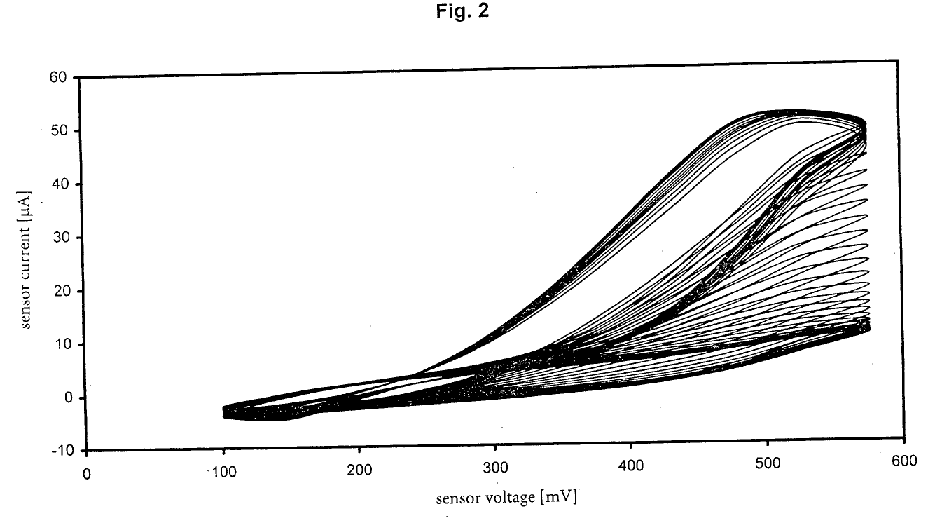

c) When the sensor obtained in this manner is used to determine blood coagulation a function curve (current versus time) is obtained as shown in FIG. 1. FIG. 2 shows the function curve of a sensor with a reference electrode.

### EXAMPLE 2

Manufacture of a Dry Chemistry Format for an ACT Test:

a) Formulation of the bulk reagent

| | | | |
|---|---|---|---|
| Concentration | | | |
| (in brackets allowed | | | |
| range according to | | Function of the | |
| the invention) | Substance | substance | Supplier |

Formulation (alternative 1):

| | | | |
|---|---|---|---|
| 0.6% (0.1-5%) | Avicel RC 591 | film former | FMC |
| | (carboxylated | | corporation |
| | microcrystalline | | |
| | cellulose) | | |
| 2% (0-5%) | Natrosol 250 M | thickener | Aqualon |
| 0.05% (0-5%) | Polyox 750 | film former | Union Carbide |
| 0.9% (0.05-5%) | Triton X100 | detergent | Sigma |
| 200 mM | HEPES | buffer | Roche |
| (10-500 mM) | | | |
| 0.1% (0.01-1%) | BSA | stabilizing | Roche |
| | (bovine serum | protein | |
| | albumin) | | |
| 0.5% | Celite | activator of the | Sigma |
| | | intrinsic path of | |
| | | plasmatic | |
| | | coagulation | |

Formulation (alternative 2):

| | | | |
|---|---|---|---|
| 30 mg/ml | sucrose | stabilizer | Sigma |
| 10 mg/g | gelatin | film former | American |
| | | | Gelatin |
| 0.1 mg/ml | Triton X100 | detergent | Sigma |
| 40 mg/ml | glycine | buffer | Roche |
| 1% | BSA | stabilizing | Roche |
| | (bovine serum | protein | |
| | albumin) | | |
| 0.1 μg/ml | rhTF | activator of the | Stago |
| | (human recombi- | extrinsic path | |
| | nant tissue factor) | of plasmatic | |
| | | coagulation | |
| 3 mg/ml | bovine sulfatide | activator of the | Sigma |
| | | intrinsic path of | |
| | | plasmatic | |
| | | coagulation | |

b) Metering and drying

5 μl of one of these suspensions was metered on the sensor described under 1. (variant 1a, i.e. with Ag/AgCl reference electrode) and dried on a belt dryer or in a drying cabinet at 30 to 50° C.

### EXAMPLE 3

Amplification of the Measurement Signal:

A p-aminoaniline (phenylenediamine) is released from the thrombin substrate by the action of the coagulation cascade. This is oxidized on the working electrode and the electrons released in this process are detected. The primary oxidation product is a quinone diamine. Enzymatic recycling of this oxidation product into the phenylenediamine by a dye-oxidoreductase such as glucose-dye-oxidoreductase (GlucDOR) enables a renewed oxidation on the electrode and thus an amplification of the original signal.

a) Formulation of the bulk reagent:

| Concentration (in | | | |
|---|---|---|---|
| brackets allowed | | | |
| range according | | Function of the | |
| to the invention) | Substance | substance | Supplier |
| 0.6% (0.1-5%) | Avicel RC 591 | film former | FMC |
| | (carboxylated micro- | | corporation |
| | crystalline cellulose) | | |
| 2% (0-5%) | Natrosol 250 M | thickener | Aqualon |
| 0.05% (0-5%) | Polyox 750 | film former | Union |
| | | | Carbide |
| 0.9% (0.05-5%) | Triton X100 | detergent | Sigma |
| 200 mM | HEPES | buffer | Roche |
| (10-500 mM) | | | |
| 0.1% (0.01-1%) | BSA | stabilizing | Roche |
| | (bovine serum | protein | Diagnostics |
| | albumin) | | |
| 0.1 μg/ml | rhTF | activator of the | Stago |
| (0.01-2 μg/ml) | (human recombinant | extrinsic path | |
| | tissue factor) | of plasmatic | |
| | | coagulation | |
| 1.2 KU/g | glucose-dye- | enzyme | Roche |
| (0.01-10 KU/g) | oxidoreductase | | |
| | (GlucDOR) | | |

The glucose required as a substrate for the amplification enzyme GlucDOR is a component of the sample (ca. 10 mM) and was therefore not incorporated into the formulation. However, in principle it is possible to add glucose.

b) Metering and drying

5 μl of this suspension was metered on the sensor described under 1.I.a. and dried on a belt dryer or in a drying cabinet at 30 to 50° C.

### EXAMPLE 4

Electochemical ACT Test

a) Test composition

The test composition (sensor) used in this example corresponded to the sensor described in 1.I.b) (use of a type 2 mediator).

b) Formulation of the bulk reagent

| Concentration (in | | | |
|---|---|---|---|
| brackets allowed | | | |
| range according | | Function of the | |
| to the invention) | Substance | substance | Supplier |
| 0.6% (0.1-5%) | Avicel RC 591 | film former | FMC |
| | (carboxylated micro- | | corporation |
| | crystalline cellulose) | | |
| 2% (0-5%) | Natrosol 250 M | thickener | Aqualon |
| 0.05% (0-5%) | Polyox 750 | film former | Union |
| | | | Carbide |
| 0.9% (0.05-5%) | Triton X100 | detergent | Sigma |
| 200 mM | HEPES | buffer | Roche |
| (10-500 mM) | | | |
| 0.1% | BSA | stabilizing | Roche |
| (0.01-1%) | (bovine serum | protein | |
| | albumin) | | |
| 0.2 μg/ml | rhTF | activator of the | Stago |
| (0.01-2 μg/ml) | (human recombinant | extrinsic path | |
| | tissue factor) | of plasmatic | |
| | | coagulation | |
| 6 mg/ml | bovine sulfatide | activator of the | Life Science |
| (0.5-50 mg/ml) | | extrinsic path | Research |
| | | of plasmatic | |
| | | coagulation | |
| 50 mM | p-nitroso-bis- | type 2 mediator | Roche |
| (1-250 mM) | hydroxyethylaniline | | |

c) Metering and drying

5 μl of this suspension was metered on the sensor described under a) and dried on a belt dryer or in a drying cabinet at 30 to 50° C.

d) Results of the measurement for the ACT test

An ACT test was carried out with the sensor described above using whole blood samples to which 1 to 6 U heparin per ml was added (heparin spike). A potential of 300 mV was applied and the time was read at a threshold value of 0.5 μA. The results are shown the following table:

| Heparin concentration [U/ml] | Clotting time [s] |
|---|---|
| 1 | 47 |
| 2 | 100 |
| 3 | 172 |
| 4 | 235 |
| 5 | 279 |
| 6 | 353 |

### EXAMPLE 5

Electochemical aPTT Test

a) Test composition:

The test composition used in this example corresponded to the composition described in 1.I.b).

b) Formulation of the bulk reagent:

| Concentration (in | | | |
|---|---|---|---|
| brackets allowed | | | |
| range according | | Function of the | |
| to the invention) | Substance | substance | Supplier |
| 0.6% (0.1-5%) | Avicel RC 591 | film former | FMC |
| | (carboxylated micro- | | corporation |
| | crystalline cellulose) | | |
| 2% (0-5%) | Natrosol 250 M | thickener | Aqualon |
| 0.05% (0-5%) | Polyox 750 | film former | Union |
| | | | Carbide |
| 0.9% (0.05-5%) | Triton X100 | detergent | Sigma |
| 200 mM | HEPES | buffer | Roche |
| (10-500 mM) | | | |
| 0.1% | BSA | stabilizing | Roche |
| (0.01-1%) | (bovine serum | protein | Diagnostics |
| | albumin) | | |
| 0.6 mg/ml | soy bean | activator of the | Sigma |
| (0.05-10 mg/ml) | phosphatides | extrinsic path | |
| | | of plasmatic | |
| | | coagulation | |
| 1 mg/ml | bovine sulfatide | activator of the | Life Science |
| (0.1-10 mg/ml) | | extrinsic path | Research |
| | | of plasmatic | |
| | | coagulation | |
| 50 mM | p-nitroso-bis- | type 2 mediator | Roche |
| (1-250 mM) | hydroxyethylaniline | | |

c) Metering and drying

5 μl of this suspension was metered on the sensor described under 1.I.b) and dried on a belt dryer or in a drying cabinet at 30 to 50° C.

d) Results of the measurement for the aPTT test

An aPTT test was carried out with the sensor described above using whole blood samples to which 0 to 0.35 U heparin per ml was added (heparin spike). A potential of 300 mV was applied and the time was read at a threshold value of 0.5 μA. The results are shown in the following table:

| Heparin concentration [U/ml] | Clotting time [s] |
|---|---|
| 0 | 59 |
| 0.15 | 79 |
| 0.25 | 117 |
| 0.35 | 164 |

### EXAMPLE 6

Compensation of the Haematocrit Effect

I. Description of the Method:

In chronoamperometric or voltammetric measuring methods the current resulting from an oxidation or reduction depends on the haematocrit when using whole blood as the analyte. Hence in evaluation methods which are based on a defined current threshold to determine the clotting time, different clotting times are determined depending on the haematocrit.

The haematocrit can be measured by a special measurement algorithm and used to correct the current measurements. For this purpose a brief measurement of the apparent resistance of the sensor wetted with blood is carried out before the actual chronoamperometric measurement. For this an alternating voltage with a frequency of 2 kHz and an amplitude of about 10 mV is applied between the working electrode and the counterelectrode and the resulting effective value of the alternating current flowing through the sensor is measured. The apparent resistance Z of the sensor filled with the blood sample is obtained by dividing the effective value of the applied voltage with the effective value of the alternating current. This apparent resistance Z is dependent on the temperature and the haematocrit of the blood. Under thermostatted isothermal conditions it is thus possible to measure the haematocrit in the blood independent of the concentration of the actual electron carrier (mediator).

The current values of the actual chronoamperometric detection measurement (iₘₑₛₛ) can then be corrected using the following formula in order to thus obtain results (i_{corr}) which are independent of the haematocrit content:

I_{corr}=iₘₑₛₛ×((Z−Z_{median})×0.001+1)

in which Z is the apparent resistance of the actual measurement and Z_{median} is the apparent resistance of the average of many blood samples and is derived as the result of a batch calibration.

II. Experimental Procedure

II.1 Preparation of the Dry Chemistry Format for the PT Test:

Compensation for the haematocrit effect is demonstrated using a PT test as an example. The test composition used in this example corresponded to the composition described in example 1 under Ib). The formulation used was identical to formulation 2 described in section IIa) of example 1.

II.2 Setting the Haematocrit Values

Fresh venous blood was cooled on an ice bath to 0° C. Aliquots were separated in a bench centrifuge into erythrocytes and cell pellet. High haematocrits were set by removing part of the plasma and resuspending the cells in the remaining plasma. Low haematocrits were obtained by adding plasma which had been obtained from another aliquot of the same blood as already described.

The experimental results are shown in the following table:

Clotting times [s]

| Haematocrit [%] | uncorrected | corrected |
|---|---|---|
| 35 | 39 | 52 |
| 45 | 45 | 53 |
| 65 | 78 | 56 |

### EXAMPLE 7

Voltammetric Method

In addition to the described amperometric measuring methods, it is also possible to use voltammetric measuring methods. In this case the voltage between the electrodes is not set to be constant, but rather the voltage is changed linearly from an initial value to a final value and subsequently returned to the initial value. This process can be repeated several times over the entire measurement period. In this method the current is then plotted against the voltage and when this is repeated, one obtains a nested set of current-voltage curves (cyclovoltammograms). If the voltage range is suitable, oxidation peaks and reduction peaks of the electron carrier are formed in these curves.

An example of such consecutive voltammograms is shown in FIG. 2. A sweep through the potential range 100 to 600 mV and back was repeated over the entire measurement period.

The height of these peaks is directly proportional to the concentration of the electron carrier provided that other redox-active substances are not co-oxidized or co-reduced in the covered potential range and thus additionally contribute to the current. Such an interference may be ignored when measuring a concentration change.

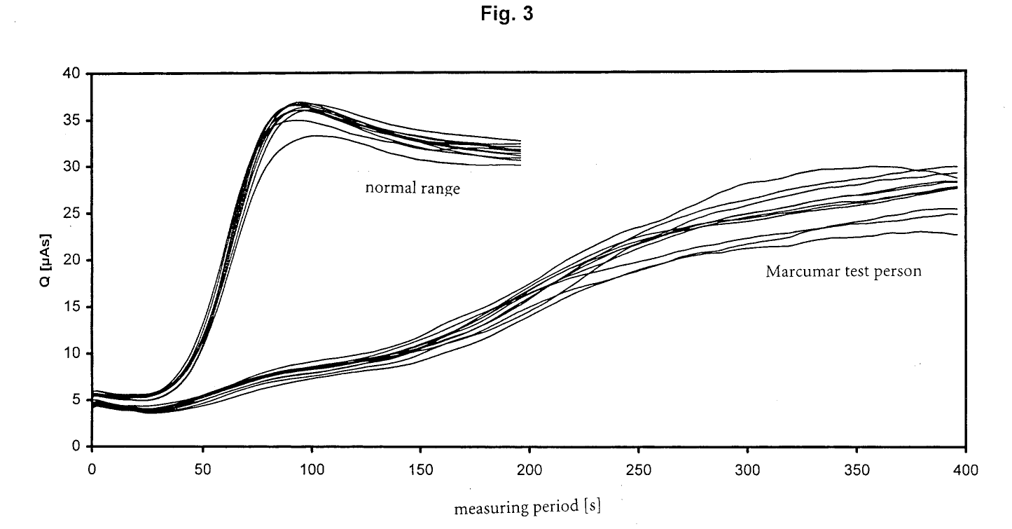

If the current values for the peak maxima or the areas enclosed by the curves (corresponding to the charge turnover) of the individual current voltage loops are plotted against time, one also obtains a picture of the concentration change of the electron carrier over the measurement period in a time raster given by the cycle period. The charge content (sum of the current values/measurement density) of the consecutive cyclic voltammograms is plotted over time in FIG. 3. The difference in the time course between the normal coagulation range and the result of a Marcumar test person (with retarded blood clotting) can be seen.

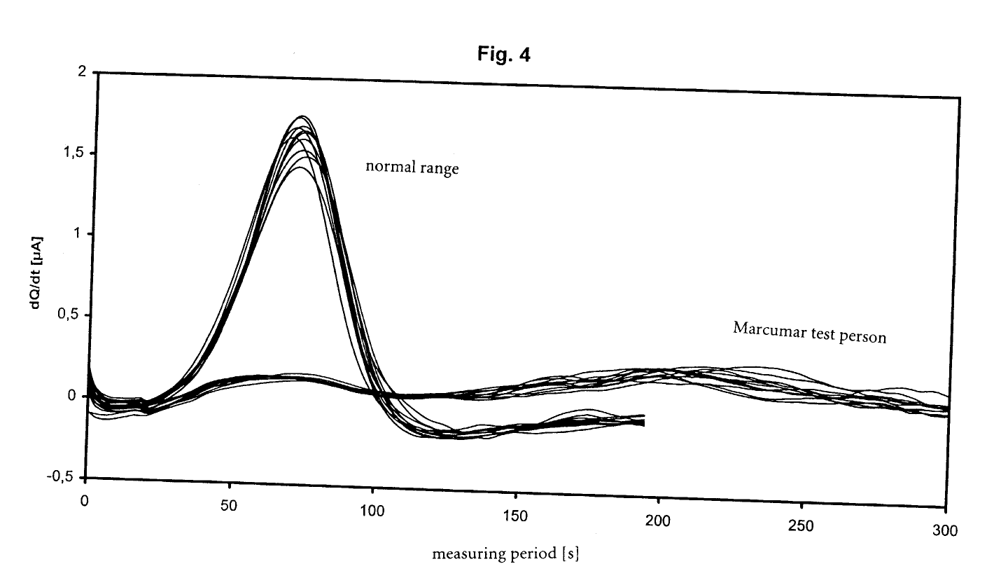

The time at which the charge of a cyclic voltammogram starts to increase and how rapidly this occurs is of primary interest in order to determine or read a clotting time. Hence this means when does coagulation start (thrombin is activated) and how rapidly does this occur (how rapidly is how much thrombin additionally activated). For this reason, as shown in FIG. 4, the time derivative is calculated from the curves of FIG. 3 i.e. dQ to dt. The maximum slope is the maximum in the time derivative. The time t of the maximum can be read as the clotting time.

The following result is then obtained for the examples shown in FIGS. 3 and 4:

Time until maximum dQ/dt

| Measurement | Normal range | Marcumar test person |
|---|---|---|
| 1 | 74 | 208 |
| 2 | 70 | 200 |
| 3 | 72 | 196 |
| 4 | 74 | 200 |
| 5 | 72 | 196 |
| 6 | 74 | 188 |
| 7 | 74 | 208 |
| 8 | 74 | 216 |
| 9 | 74 | 204 |
| 10 | 74 | 234 |
| 11 | 76 | 218 |

1. Electrochemical sensor based on dry chemistry for determining blood coagulation or individual coagulation factors which has at least two electrodes on an inert support as well as a dry reagent, characterized in that the reagent contains a protease substrate which is composed of a peptide residue that can be cleaved off by a protease of the blood coagulation system and is bound to substituted anilines and in particular to a phenylenediamine residue via an amide bond at its carboxyl end.

2. Electrochemical sensor as claimed in claim 1, characterized in that it contains two electrodes which are composed of the same material.

3. Electrochemical sensor as claimed in claim 2, characterized in that the electrode material is palladium.

4. Electrochemical sensor as claimed in one of the claims 1 or 3, characterized in that the protease is thrombin and the protease substrate is a thrombin substrate.

5. Electrochemical sensor as claimed in claim 4, characterized in that the thrombin substrate is a compound of formula VI, 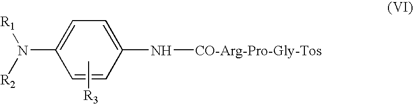
in which
R1 denotes an alkyl residue or hydrogen,
R2 denotes a hydroxyalkyl residue or hydrogen and
R3 denotes hydrogen, halogen, alkoxy or alkylthio.

6. Electrochemical sensor as claimed in one of the claims 1-5, characterized in that the reagent also contains a dye-oxidoreductase which is able to catalyse the conversion of a quinone diamine into a phenylenediamine.

7. Electrochemical sensor as claimed in claim 6, characterized in that the dye-oxidoreductase is glucose-dye-oxidoreductase.

8. System for measuring blood coagulation containing an electrochemical sensor and an instrument for measuring current, characterized in that a sensor as claimed in one of the claims 1-7 is used as the sensor.

9. Method for determining blood coagulation by means of an electrochemical sensor, characterized in that a constant voltage is applied to a sensor as claimed in one of the claims 1-7, the blood sample to be examined is applied to the sensor in such a manner that the reagent and the electrodes are moistened and the current flowing between the electrodes is measured over time.

10. Method as claimed in claim 9, characterized in that it is used to measure the prothrombin time (PT), the activated partial prothrombin time (aPTT) or the activated clotting time (ACT).

11. Method as claimed in claim 9 or 10, characterized in that the determination of the blood clotting time is corrected for haematocrit influence by means of an impedance measurement.

12. Reagent for the determination of blood coagulation containing a protease substrate which is composed of a peptide residue that can be cleaved off by a protease of the blood coagulation system which is bound via its carboxyl end and an amide linkage to a phenylenediamine residue, characterized in that it contains a dye-oxidoreductase.

13. Reagent as claimed in claim 12, characterized in that the dye-oxidoreductase is glucose-dye-oxidoreductase.

14. Reagent as claimed in claim 12 or 13, characterized in that the protease is thrombin and the protease substrate is a thrombin substrate.

15. Method for determining the blood coagulation by means of an electrochemical sensor, characterized in that a voltage that changes linearly is applied to a sensor as claimed in one of the claims 1-7, the blood sample to be examined is applied to the sensor in such a way that the reagent and the electrodes are moistened and the current flowing between the electrodes is measured over time.

16. Method as claimed in claim 15, characterized in that the determination of the blood clotting time is corrected for haematocrit influence by means of an impedance measurement.
